(19) United States
(12) Patent Application Publication
(10) Pub. No.: US 2008/0154591 A1
(43) Pub. Date: Jun. 26, 2008

(54) Audio Recognition System For Generating Response Audio by Using Audio Data Extracted

(76) Inventors: Toshihiro Kujirai, Kokubunji (JP); Takahisa Tomoda, Sagamihara (JP); Minoru Tomikashi, Yokohama (JP); Takeshi Oono, Yokohama (JP)

Correspondence Address: REED SMITH LLP, 3110 FAIRVIEW PARK DRIVE, SUITE 1400, FALLS CHURCH, VA, 22042, US

(21) Appl. No.: 11/883,558

(22) PCT Filed: Feb. 3, 2006
(86) PCT No.: PCT/JP2006/002283

§ 371 Date: Aug. 2, 2007

(30) Foreign Application Priority Data
Feb. 4, 2005 (JP) 2005-028723

(51) Int. Cl. G10L 15/00

(52) U.S. Cl. 704/231; 704/E15.001

(57) ABSTRACT

Provided are a voice recognition system for making a response based on an input of a voice uttered by a user including: an audio input unit for converting the uttered voice into voice data; a voice recognizing unit for recognizing a combination of terms constituting the voice data and calculating reliability of recognition of each of the terms; a response generating unit for generating a voice response; and an audio output unit for presenting the user with information using the voice response. The response generating unit: generates synthesis audio for a term whose calculated reliability satisfies a predetermined condition; extracts from the voice data a part corresponding to a term whose calculated reliability does not satisfy the predetermined condition; and generates the voice response based on at least one of the synthesis audio, the extracted voice data and a combination of the synthesis audio and the extracted voice data.

### FIELD OF THE INVENTION

This invention relates to a voice recognition system, a voice recognition device, and an audio generation program for making a response based on an input of a voice of a user using a voice recognition technique.

### BACKGROUND OF THE INVENTION

In current voice recognition techniques, patterns for collation are generated by learning acoustic models of unit standard patterns that constitute an utterance based on a large amount of voice data, and connecting the acoustic models of the unit standard patterns in accordance with a lexicon which is a vocabulary group to be a recognition target.

For example, syllables, a vowel stationary part, a consonant stationary part, and sub-phonetic segment composed of transition part between a vowel normal part and a consonant normal part are used as the unit standard patterns. Further, a technique of hidden markov models (HMM) is used as expression means of the unit standard patterns.

In other words, the technique as described above is a pattern matching technique of matching standard patterns created based on the large amount of data with input signals.

Further, for example, in a case where two sentences of “turn up a volume” and “turn down a volume” are to be a recognition target, there are known a method in which each of the sentences as a whole is set as the recognition target, and a method in which parts that constitute the sentence are registered in the lexicon as words and combinations of the words are set as the recognition target.

In addition, results of voice recognition are notified to users by a method of displaying a recognition result character string on a screen, a method of converting the recognition result character string into synthesis audio through audio synthesis and playback the synthesis audio, and/or a method of playback audio that has been pre-recorded according to the recognition result.

Further, instead of simply notifying the result of the voice recognition, there is also known a method involving displaying characters including a sentence for confirmation, such as “is it correct to say” before a word or sentence obtained as the recognition result or using synthesis audio, to thereby interact with a user.

Further, in general, the current voice recognition techniques select as the recognition result words most similar to words uttered by the user among a vocabulary registered as a recognition vocabulary, and output reliability which is a measure for reliability of the recognition result.

As an example of a method of calculating reliability of a recognition result, JP 04-255900 A discloses a voice recognition technique of calculating by a comparative collation unit 2 a similarity between a feature vector V of an input voice and a plurality of standard patterns that have been pre-registered. At this time, a standard pattern that provides a maximum similarity value S is obtained as the recognition result. Simultaneously, a reference similarity calculation unit 4 compares and collates the feature vector V with the standard pattern formed by connecting unit standard patterns in a unit standard pattern storage unit 3. Here, the maximum value of the similarity is output as a reference similarity R. Then, a similarity correction unit 5 uses the reference similarity R to correct the similarity S. The reliability can thus be calculated by the similarity.

As a utilization method of the reliability, there is known a method of notifying, when the reliability of the recognition result is low, a user that recognition has not been carried out normally.

Further, JP 06-110650 A discloses a technique in which, by registering patterns that cannot serve as keywords when it is difficult to register all keyword patterns since the number of keywords such as names is large, a keyword part is extracted, and the keyword part which has been obtained by recording a voice uttered by a user is combined with audio provided by a system, to thereby generate a voice response.

### SUMMARY OF THE INVENTION

As described above, a current voice recognition system based on a pattern matching technique with a lexicon cannot completely prevent an erroneous recognition in which an utterance of a user is mistaken as other words in the lexicon. Further, in a method in which a combination of words is set as a recognition target, it is necessary to correctly recognize which part of the utterance of the user corresponds to which word. Thus, there are cases where, because a wrong part has been recognized to correspond to a certain word, other words are also erroneously recognized due to a propagation effect of a deviation in correspondence. Further, in a case where a word which is not registered in the lexicon is uttered, it is impossible to correctly recognize the uttered word in theory.

In order to effectively utilize the imperfect recognition technique as described above, it is necessary to notify with accuracy the user of which part of the user utterance has been correctly recognized and which part thereof has not been correctly recognized. However, the requirement has not been sufficiently met by a conventional method of notifying a user of a recognition result character string through a screen or through audio, or by merely notifying the user that recognition has not been carried out normally in a case of low reliability.

This invention has been made in view of the above-mentioned problems and therefore has an object to provide a voice recognition system for generating feedback audio for user notification by using, according to reliability of each word constituting a voice recognition result, synthesis audio for words with high reliability and in a case of words with low reliability, using fragments of a user utterance corresponding to the words.

According to representative aspect of this invention, there is provided a voice recognition system for making a response based on an input of a voice uttered by a user, including: an audio input unit for converting the voice uttered by the user into voice data; a voice recognizing unit for recognizing a combination of terms constituting the voice data and calculating reliability of recognition of each of the terms; a response generating unit for generating a voice response; and an audio output unit for presenting the user with information using the voice response. The response generating unit is configured to: generate synthesis audio for a term whose calculated reliability satisfies a predetermined condition; extract from the voice data a part corresponding to a term whose calculated reliability does not satisfy the predetermined condition; and generate the voice response based on at least one of the synthesis audio, the extracted voice data and a combination of the synthesis audio and the extracted voice data.

According to an aspect this invention, a voice recognition system with which a user can instinctively understand which part of a user utterance has been recognized and which part thereof has not been recognized can be provided. Further, there can be provided a voice recognition system with which the user can understand that voice recognition has not been carried out normally since erroneous confirmation by the voice recognition system is reproduced in such a manner that the user can instinctively understand an abnormality, for example, in such a manner that fragments of the utterance of the user to be notified thereto is broken in a midst thereof.

### BRIEF DESCRIPTION OF THE DRAWINGS

FIG. 1 is a block diagram showing a structure of a voice recognition system according to an embodiment of this invention.

FIG. 2 is a flowchart showing an operation of a response generating unit according to the embodiment of this invention.

FIG. 3 is a diagram showing an example of a voice response according to the embodiment of this invention.

FIG. 4 is a diagram showing another example of the voice response according to the embodiment of this invention.

### DETAILED DESCRIPTION OF THE PREFERRED EMBODIMENT

Hereinafter, a voice recognition system according to an embodiment of this invention will be described with reference to the drawings.

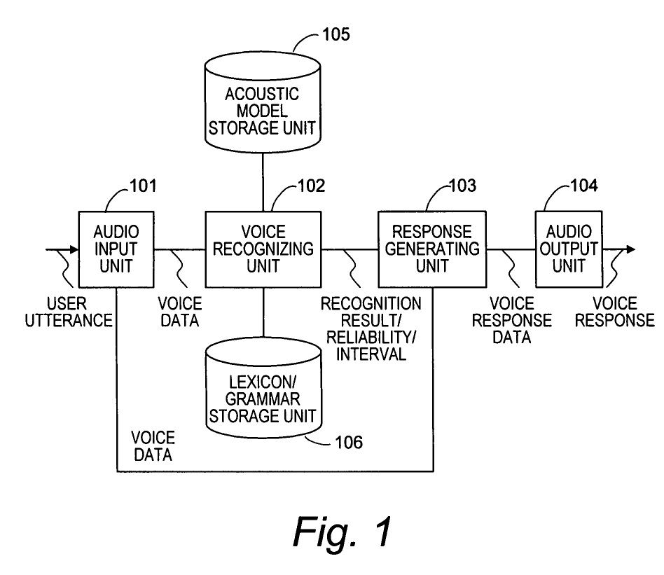

FIG. 1 is a block diagram showing a structure of the voice recognition system according to the embodiment of this invention.

The voice recognition system according to this invention includes an audio input unit 101, a voice recognizing unit 102, a response generating unit 103, an audio output unit 104, an acoustic model storage unit 105, and a lexicon/grammar storage unit 106.

The audio input unit 101 receives a voice uttered by a user and converts the voice into voice data in a digital signal format. The audio input unit 101 is composed of, for example, a microphone and an A/D converter, and a voice signal input through the microphone is converted into a digital signal by the A/D converter. The converted digital signal (voice data) is transmitted to the voice recognizing unit 102 and/or the response generating unit 103.

The acoustic model storage unit 105 stores a database including an acoustic model. The acoustic model storage unit 105 is composed of, for example, a hard disk drive or a ROM.

The acoustic model is data expressing what kind of voice data is obtained from utterances of the user in a statistic model. The acoustic model is modeled based on syllables (e.g., in units of “a”, “i”, and the like). A unit of sub-phonetic segment can be used as the unit for modeling in addition to units in syllables. The unit of sub-phonetic segment is data obtained by modeling a vowel, a consonant, and silence as a stationary part and modeling a part in a middle of a shift between the different stationary parts, such as from the vowel to the consonant and from the consonant to the silence, as a transition part. For example, the term “aki” is divided as follows: “silence”, “silence, a” , “ak”, “k”, “ki”, “i, i, silence”, and “silence”. Further, HMM or the like is used as a method for the statistic modeling.

The lexicon/grammar storage unit 106 stores lexicon data and grammar data for recognizing. The lexicon/grammar storage unit 106 is composed of, for example, a hard disk drive or a ROM.

The lexicon data and the grammar data are pieces of information related to combinations of a plurality of terms and sentences. Specifically, the lexicon data and the grammar data are pieces of data for designating a way to combine the acoustic-modeled units described above in order to construct an effective term or sentence. The lexicon data is data designating a combination of syllables as in the example described above using the word “aki”. The grammar data is data designating a group of combinations of terms to be accepted by the system. For example, in order for the system to accept an utterance of, for example, “go to Tokyo Station”, it is necessary that a combination of three terms of “go”, “to” and “Tokyo Station” is included in the grammar data. In addition, classification information is given to each term stored in the grammar data. For example, the term “Tokyo Station” can be classified as a “place” and the term “go” can be classified as a “command”. Further, the term “to” is classified as a “non-keyword”. The terms which have a classification of “non-keyword” do not affect an operation of the system even when recognized. In contrast, a term which has a classification other than the “non-keyword” is a keyword that affects the system in some operation when recognized. When a term classified as the “command” is recognized, for example, calling a function that corresponds to the recognized term is carried out. Whereby a term recognized as the “place” can be used as a parameter in the called function.

The voice recognizing unit 102 acquires a recognition result based on the voice data converted by the audio input unit 101, and calculates a similarity thereof. The voice recognizing unit 102 acquires, by using the lexicon data and/or the grammar data stored in the lexicon/grammar storage unit 106 and the acoustic models stored in the acoustic model storage unit 105, a term or a sentence to which designation of a combination of acoustic models has been made, based on the voice data. A similarity between the acquired term or sentence and the voice data is calculated. Then, a recognition result of the term or sentence having a high similarity is output.

It should be noted that a sentence includes a plurality of terms that constitute the sentence. After that, reliability is given to each of the terms constituting the recognition result, and the reliability is output together with the recognition result.

The similarity can be calculated by using a method disclosed in JP 04-255900 A. In addition, when calculating the similarity, which part of the voice data each of the terms constituting the recognition result is to be associated with so that the similarity becomes highest can be obtained by using a Viterbi algorithm. By using the Viterbi algorithm, section information indicating a part of the voice data associated with each term is output together with the recognition result. Specifically, voice data received every predetermined interval (e.g., 10 milliseconds) (will be referred to as frame) and information in a case where a similarity can be made highest regarding the association of sub-phonetic segment constituting the term are output.

The response generating unit 103 generates voice response data based on the recognition result provided with reliability, which has been output from the voice recognizing unit 102. Processing executed by the response generating unit 103 will be described later.

The audio output unit 104 converts the voice response data in a digital signal format generated by the response generating unit 103 into audio that can be understood by people. The audio output unit 104 is composed of, for example, a digital to analog (D/A) converter and a speaker. Input audio data is converted into an analog signal by the D/A converter and the converted analog signal (voice signal) is output to the user through the speaker.

Next, an operation of the response generating unit 103 will be described.

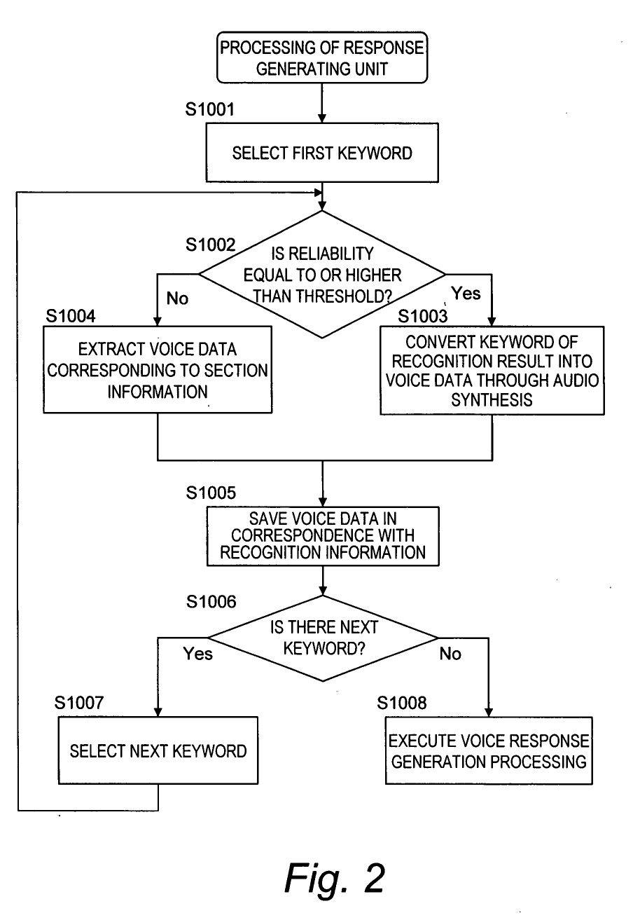

FIG. 2 is a flowchart showing processing executed by the response generating unit 103.

The processing is executed upon output of a recognition result which is given reliability from the voice recognizing unit 102.

First, information on a first keyword contained in the input recognition result is selected (S1001). The recognition result is composed of time-series term units of the original voice data sectioned based on section information. Therefore, a keyword at the top of the time series is selected. A term classified as the “non-keyword” does not affect the voice response and is thus ignored. Further, because the recognition result is given reliability and section information for each term, the reliability and the section information given to the term are selected.

Next, judgement is made on whether the reliability of the selected keyword is equal to or higher than a predetermined threshold (S1002). When it is judged that the reliability is equal to or higher than the threshold, the processing proceeds to Step S1003. When it is judged that the reliability is below the threshold, the processing proceeds to Step S1004.

When it is judged that the reliability of the selected keyword is equal to or higher than the predetermined threshold, it means that the combination of the acoustic models designated by the lexicon data or the grammar data is similar to the utterance of the input voice data and that the keyword is successfully recognized. In this case, synthesis audio of the keyword of the recognition result is synthesized to convert the synthesis audio into voice data (S1003). The actual audio synthesis processing is carried out in this step. However, the audio synthesis processing may collectively be carried out in the voice response generation processing of Step S1008 with a response sentence prepared by the system. In either case, by using the same audio synthesis engine, the keyword recognized with high reliability can be synthesized naturally with the same sound quality as that of the response sentence prepared by the system.

On the other hand, when it is judged that the reliability of the selected keyword is lower than the predetermined threshold, it means that the combination of the acoustic models designated by the lexicon data or the grammar data is far different from the utterance of the input voice data, and that the keyword is not successfully recognized. In this case, synthesis audio is not generated and the user utterance is used as it is as the voice data. Specifically, parts of the voice data corresponding to the terms are extracted by using the section information provided to the terms of the recognition result. The extracted pieces of voice data become voice data to be output (S1004). Accordingly, because parts with low reliability have a sound quality different from that of the response sentence prepared by the system or the part having high reliability, the user can easily understand which part of the voice data is a part with low reliability.

By executing Steps S1003 and S1004, voice data corresponding to the keywords of the recognition result can be obtained. After that, the voice data is saved as data correlated with the terms of the recognition result (S1005).

Next, judgment is made on whether the input recognition result includes a next keyword (S1006). Because terms in the recognition result are obtained in time-series from the original voice data, judgment is made on whether there is a keyword next to the keyword that has been processed through Steps S1002 to S1005. When it is judged that there is a next keyword, the next keyword is selected (S1007). Then, Steps S1002 to S1006 described above are executed.

On the other hand, when it is judged that there is no next keyword, it means that all the keywords included in the recognition result have been given to voice data corresponding to the keyword. Thus, the voice response generation processing is executed by using the recognition result provided with the voice data (S1008).

In the voice response generation processing, voice response data for notification to the user is generated by using the pieces of voice data associated with all the keywords contained in the recognition result.

In the voice response generation processing, for example, pieces of voice data associated with the respective keywords are combined or pieces of additionally-prepared voice data are combined, to thereby generate a voice response for notifying the user of the voice recognition result or a part with which voice recognition has failed (keyword whose reliability does not satisfy the predetermined threshold).

A combining method of the voice data varies depending on the interaction held between the system and the user, and the situation. Thus, it is necessary to employ a program or an interaction scenario for changing the combining method of the voice data according to situations.

In this embodiment, the voice response generation processing will be described by way of the following examples.
(1) The user utters “Omiya Park in Saitama”.
(2) Terms constituting the recognition result are three terms of “Omiya Park”, “in” and “Saitama”, and two keywords are “Omiya Park” and “Saitama”.
(3) The term having higher reliability than the predetermined threshold is only “Saitama”.

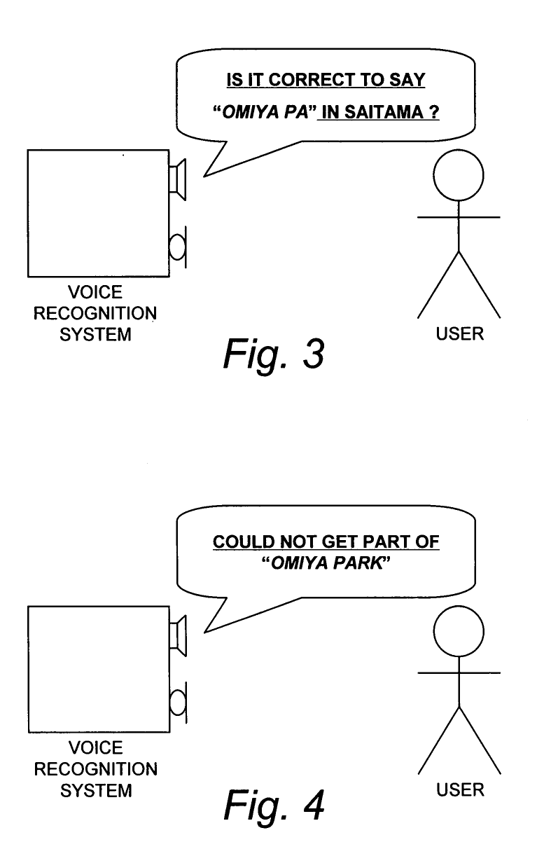

First, a first method will be described. The first method is a method of indicating to the user the recognition result of the voice uttered by the user. Specifically, referring to FIG. 3, voice response data obtained by putting together the voice data corresponding to the keyword of the recognition result and the voice data including words for confirmation prepared by the system, such as “in” or “is it correct to say”, is generated.

In the first method, a voice response is produced by a combination of the voice data “Saitama” produced through audio synthesis (indicated with an underline in FIG. 3), the voice data “Omiya Pa” extracted from the voice data of the utterance of the user (shown in italic in FIG. 3), and the voice data “in” and “is it correct to say” produced through audio synthesis (shown with an underline in FIG. 3), and a response is made to the user using the produced voice response. In other words, the “Omiya Pa” part having reliability lower than the predetermined threshold and having a possibility of being erroneously recognized is output as it is in a voice uttered by the user for response.

With the structure as described above, for example, even when the voice recognizing unit 102 erroneously recognizes “Omiya Park” as “Owada Park”, the user hears a voice of “Omiya Park” uttered by him/herself as the voice response. Accordingly, whether the recognition result of the term generated by the audio synthesis among the recognition results, that is, the term (“Saitama”) having reliability equal to or higher than the predetermined threshold, is correct can be confirmed, and whether the term having reliability lower than the predetermined threshold (“Omiya Park”) is correctly recorded in the system can be confirmed. For example, when a ending part of the user utterance is not correctly recorded, the user hears an inquiry such as “is it correct to say” “Omiya Pa ” in “Saitama”. Thus, the user can understand whether the section information of each term determined by the system is correctly determined and recorded so that the user can try a re-input.

This method is preferable, for example, in a case where a task of organizing verbal questionnaire surveys regarding popular parks for each prefecture is conducted using the voice recognition system. In this case, the voice recognition system can automatically organize only the number of cases for each prefecture according to the voice recognition results. Further, the “Omiya Park” part of the recognition result having low reliability is dealt with by using a method involving an operator hearing the word and inputting the word afterward.

Therefore, in the first method, the part of the voice of the user that has been correctly recognized can be confirmed by the user, and the user can confirm whether the part of the voice that has not been correctly recognized is correctly recorded in the system.

Next, a second method will be described. The second method is a method of making an inquiry to the user of only the part of which the recognition result is doubtful. Specifically, referring to FIG. 4, the second method is a method of combining voice data for confirmation such as “could not get the part xx” with the voice data “Omiya Park” of the recognition result having low reliability.

In the second method, the voice data “Omiya Park” extracted from the voice data of the utterance of the user (shown in italic in FIG. 4) and the voice data “could not get the part” produced through audio synthesis (indicated with an underline in FIG. 4) are combined to produce a voice response, and a response is made to the user using the produced voice response. In other words, the “Omiya Park” part that has the reliability lower than the predetermined threshold and has a possibility of being erroneously recognized is output as it is in a voice uttered by the user for the response. Then, the user is notified that the voice recognition has failed. After that, audio is output to instruct the user to re-input the voice again or the like.

It should be noted that when the “Omiya Park” part is recognized as two parts of “Omiya” and “Park” as the recognition result, and the reliability of the “Park” part alone is equal to or higher than the predetermined threshold, a response method as described below may be used. Specifically, after a response is made by the combination of the voice data “Omiya Park” of the user utterance and the voice data “can not be recognized” produced through audio synthesis, audio such as “which park is it” or “please speak like Amanuma Park” is generated and output as a response, to thereby prompt the user of the re-utterance. It should be noted that the latter case is desirably avoided because using the term “Omiya Park” of the recognition result having low reliability as an example of a response may confuse the user.

Therefore, in the second method, it is possible to accurately notify the user of which part of the user utterance has been recognized and which part of the user utterance has not been recognized. Further, in the case where the user utters “Omiya Park in Saitama”, when the reliability of the “Omiya Park” part becomes low because of surrounding noises, the surrounding noises are recorded in the “Omiya Park” part of the voice response. Thus, the user can easily understand that the surrounding noises are the cause of the erroneous recognition. In this case, the user can think about trying the utterance at a timing at which the surrounding noises are small, move to a place with less surrounding noise, or stop the car when the user is in the car, for reducing an influence of the surrounding noises.

In addition, when the voice data is not captured because the utterance of the “Omiya Park” part is too small, the part of the voice response heard by the user, which corresponds to the “Omiya Park”, becomes silence, whereby the user can easily understand that the “Omiya Park” part has not been captured by the system. In this case, the user can think about trying the utterance in a louder voice, or trying the utterance by bringing the mouth close to the microphone to ensure that the voice is captured.

Further, when the terms of the recognition result are erroneously divided into terms as “Saitama”, “in O”, and “miya Park”, the user hears “miya Park” in the voice response. Therefore, the user can easily know that the system has failed in association of the voice. Even when the voice recognition result is an error, when the term is mistaken for an extremely similar term, the user may forgive the erroneous recognition since it is likely to occur also in interactions among people. However, when the term is erroneously recognized as a term totally different in pronunciation, the user may become very doubtful of the performance of the voice recognition system.

As described above, by notifying the user of the failure in association, the user can predict the cause of the erroneous recognition and it can be expected that the user accepts the consequence to some extent.

Further, in the examples described above, at least the “Saitama” part of the terms has the reliability equal to or higher than the predetermined threshold, and is thus correctly recognized. Thus, data of the lexicon/grammar storage unit 106 to be used by the voice recognizing unit 102 is limited to contents related to the parks in Saitama prefecture. With the limitation as described above, a recognition rate of the “Omiya Park” part increases at the next voice input (e.g., next utterance of a user).

The following method is described as a method of increasing, by using a part recognized with high reliability, a recognition rate of other parts of voice data of the utterance of the user.

Specifically, when the system is to support utterances of users such as “yy in xx prefecture” in the questionnaire surveys regarding not only the name of the parks but also various facilities, the number of combinations becomes extremely large, thereby reducing the recognition rate of the voice recognition. In addition, processing amounts of the system and a memory capacity necessary in the system are not practical. Thus, the “xx” part is recognized first instead of recognizing the “yy” part correctly. Then, the “yy” part is recognized by using the recognized “xx prefecture” and the lexicon data and the grammar data specialized for the xx prefecture.

The recognition rate of the “yy” part increases by using the lexicon data and the grammar data specialized for the “xx prefecture”. In this case, when all the terms in the voice data of the utterance of the user are correctly recognized and the reliability of those terms is equal to or higher than the predetermined threshold, the whole voice response is obtained through audio synthesis. Therefore, the user can feel that the system is capable of recognizing the utterance “yy in xx prefecture” regarding various facilities in various prefectures.

On the other hand, when the reliability of the result of the recognition of the “yy” part using the lexicon data and the grammar data specialized for the “xx prefecture” is lower than the predetermined threshold, as described above, a voice response such as “could not get the” “yy part” is generated by extracting the voice data of the utterance of the user, thereby prompting the user of the re-utterance.

As a method of recognizing only the “xx” part, there is a method in which one of the pieces of lexicon data of the lexicon/grammar storage unit 106 holds a description (garbage) which expresses combinations of various syllables. In other words, a combination of <garbage> <in> <name of prefecture> is used as the combination of the grammar data. The garbage part substitutes for names of facilities not registered in the lexicon.

Further, the combinations of syllables constituting the name of facilities that exist in Japan have some kind of characteristics. For example, a combination such as “station” appears more frequently than a combination such as “staton”. By using this fact, an appearance frequency of adjacent syllables is obtained from datum of facility names, and the combination of syllables having high appearance frequency is made to have a high similarity, whereby precision of adjacent syllables as a substitute for facility names can be enhanced.

As has been described above, the voice recognition system according to the embodiment of this invention can generate a voice response with which the user can instinctively understand which part of the voice input by the user has been recognized and which part thereof has not been recognized, to thereby make a response using the generated voice response. In addition, because the part which has not been correctly voice-recognized is reproduced in such a manner that the user can instinctively understand the abnormality, for example, in such a manner that the audio for notification to the user is broken in the midst thereof since the audio includes fragments of the utterance of the user him/herself, it becomes possible to understand that the voice recognition has not been carried out normally.

What is claimed is:

1. A voice recognition system for making a response based on an input of a voice uttered by a user, comprising:
an audio input unit for converting the voice uttered by the user into voice data;
a voice recognizing unit for recognizing a combination of terms constituting the voice data and calculating reliability of recognition of each of the terms;
a response generating unit for generating a voice response; and
an audio output unit for presenting the user with information using the voice response,
wherein the response generating unit is configured to:
generate synthesis audio for a term whose calculated reliability satisfies a predetermined condition;
extract from the voice data a part corresponding to a term whose calculated reliability does not satisfy the predetermined condition; and
generate the voice response based on at least one of the synthesis audio, the extracted voice data and a combination of the synthesis audio and the extracted voice data.

2. The voice recognition system according to claim 1, wherein the response generating unit is further configured to:
generate synthesis audio for prompting confirmation of the voice uttered by the user; and
generate the voice response by adding the generated synthesis audio to the combination of the voice data.

3. The voice recognition system according to claim 1, wherein the response generating unit is further configured to:
generate synthesis audio for prompting confirmation of the term whose calculated reliability does not satisfy the predetermined condition; and
generate the voice response by adding the predetermined voice response to the extracted voice data.

4. The voice recognition system according to any one of claim 1, further comprising a lexicon/grammar storage unit for saving lexicon data and grammar data used for recognizing the voice data,
wherein the voice recognizing unit is configured to:
preferentially recognize at least one of the terms constituting the voice data;
acquire the lexicon data and the grammar data which are regarding the term from the lexicon/grammar storage unit after the recognition; and
recognize other terms using the acquired lexicon data and the acquired grammar data.

5. A voice recognition device for generating a voice response based on an input of a voice, comprising:
an audio input unit for converting the voice uttered by a user into voice data;
a voice recognizing unit for recognizing a combination of terms constituting the voice data and calculating reliability of recognition of each of the terms; and
a response generating unit for generating a voice response,
wherein the response generating unit is configured to:
generate synthesis audio for a term whose calculated reliability satisfies a predetermined condition;
extract from the voice data a part corresponding to a term whose calculated reliability does not satisfy the predetermined condition; and
generate the voice response based on at least one of the synthesis audio, the extracted voice data and a combination of the synthesis audio and the extracted voice data.

6. An audio generation program for generating a voice response based on an input of a voice uttered by a user, which is executed in a system including an audio input unit for converting the voice uttered by the user into voice data, a voice recognizing unit for recognizing a combination of terms constituting the voice data and calculating reliability of recognition of each of the terms, a response generating unit for generating a voice response, and an audio output unit for presenting the user with information using the voice response, the audio generation program comprising:
a first step of generating synthesis audio for a term whose calculated reliability satisfies a predetermined condition;
a second step of extracting from the voice data a part corresponding to a term whose calculated reliability does not satisfy the predetermined condition; and
a third step of generating the voice response based on at least one of the synthesis audio, the extracted voice data and a combination of the synthesis audio and the extracted voice data.
